(19) United States
(12) Patent Application Publication
(10) Pub. No.: US 2007/0295046 A1
(43) Pub. Date: Dec. 27, 2007

(54) Method for Treating Extinguisher Powder Wastes, and Fertilizer Obtained from Such a Method

(75) Inventor: Henri Cassan, Narbonne (FR)

Correspondence Address: EGBERT LAW OFFICES, 412 MAIN STREET, 7TH FLOOR, HOUSTON, TX, 77002, US

(73) Assignee: VALORAGRI SA, Narbonne (FR)

(21) Appl. No.: 11/719,980

(22) PCT Filed: Nov. 25, 2005
(86) PCT No.: PCT/EP05/56232

§ 371 Date: Jul. 9, 2007

(30) Foreign Application Priority Data
Nov. 25, 2004 (FR) 0412520

(51) Int. Cl. C05C 3/00; C05B 7/00; C05D 1/00

(52) U.S. Cl. 71/26; 71/25; 71/64.02

(57) ABSTRACT

The invention relates to a method for treating extinguisher powder wastes with the aim of recycling the waste into agricultural fertilizers. The invention includes mixing the extinguisher powder wastes with a viscous cohesive agent, and blending a drying agent into the obtained mixture. The cohesive agent is based on sugar by-products, more particularly being vinasse or molasses. The drying agent is notably based on crushed and dried vegetables and, more particularly, on fruit pulp, for example, grape pulp.

### TECHNICAL FIELD OF THE INVENTION

This invention is within the field of the extinguisher powder waste treatment. Its purpose is a method for treating such waste aimed at upgrading and recycling them to prevent their disposal in a landfill.

### STATE OF THE ART

Extinguisher powders commonly contain products based on ammonium sulfate and ammonium phosphate and/or based on potassium carbonate and potassium sulfate. These powders are usually processed with silicon or similar insulating products to protect them from moisture and to optimize their performance as fire extinguishers.

There is the problem of waste management of such powders. Storage of such wastes is currently performed by disposing of them in landfills, Class Two Disposal to be exact, which should best be avoided. In addition, silicon treatment of extinguisher powders confers on them a fluidity that makes converting them into pellets a delicate process, with the corollary confinement difficulty of powders that are volatile and have the tendency to disperse.

To upgrade extinguisher powder waste, it has been proposed to use its potentially fertilizing properties to transform it into agricultural fertilizer. For example, document XP002345092 reveals a transformation method of extinguisher powder waste that involves mixing these powders with binding and liquid materials derived from distillery vinasse or molasses residues from the production of citric acid. To complete the fertilizer obtained complementary micro-elements are added to obtain agronomical satisfying results.

Other fertilizing products have also been proposed, that are formed from powdery particles to which liquid and/or viscous agents are added. For example, Document FR2723085 (MEAC SA) proposes a product combining a mineral support with an anti-dust additive, such as molasses and/or water. As another example, Document JP01270583 (IIDA KOGYO-SHO KK) proposes a granulated fertilizer formed from fine magnesium silicate powders mixed with viscous agents, such as molasses or synthetic resins. As another example, Document JP 2001 158685 (OJI CORN STARCH CO LTD) proposes a granulated fertilizer consisting of metal slag and starch powder. As yet another example, Document JP 56 084315 (MITSUBISHI CHEM IND LTD) proposes a granulated fertilizer consisting of a mixture of gypsum powder and molasses.

Such techniques consist, in their generality, of obtaining a fertilizer from a granulated support to which molasses are mixed. An initial drawback lies in the delicate use of these fertilizers that come in granulated form that makes them difficult to be pelletized. And yet, the use of a powdery product that can be pelletized tends to induce an irritation risk for the person handling it.

Concerning more particularly the process of upgrading extinguisher powder waste, it is desirable that its transformation into fertilizer be performed at the lowest cost. However, the granulation phase of the powders entails an additional production cost that must be avoided to make the obtained fertilizer competitive in relation to fertilizers obtained from other base products other than the extinguisher powder waste, Also, the fertilizer thus obtained must be user-friendly and must allow, in particular, its direct application by the end user. In addition, one seeks to obtain a fertilizer that can be used on the largest possible number of plant species, including young plants or buds.

There is another problem to be solved, which is soil erosion and its impoverishment in nutritional elements. The fertilizer used must be effective to allow the soil to retain its physico-chemical properties. More particularly, soil includes organic materials, humus, very reactive fine elements, such as clay, coarse siliceous and/or calcareous elements, as well as compounds based on iron, aluminum and water and air based calcium. Soil, beyond using a fertilizer, has itself a nutritional role to play for plants. Soil retains the soil solution, fixes certain nutritional elements and harbors microorganisms that contribute to the transformation of non-assimilable elements into elements that can be directly assimilated by plants. Thus, it is desirable for fertilizer to contribute to the preservation of the soil.

### PURPOSE OF THE INVENTION

The overall purpose of this invention is to propose an extinguisher powder waste treatment process that facilitates handling of the waste and allows upgrading it to avoid disposal in landfills and by recycling it into a marketable product. The aim of this invention is more specifically to propose such a method that allows obtaining an effective fertilizer at a competitive price that can be easily and directly applied by the user, while avoiding any risk of irritation and which favors soil preservation.

The inventive approach of this invention has involved exploiting the fertilizing qualities of extinguisher powder, rich in nitrogen, phosphate and potassium to recycle it into fertilizer for agricultural use, notably by spreading. To that end, this invention proposes, overall, to mix the extinguisher powder waste with a cohesive viscous agent based, especially on sugar by-products and, more particularly, based on molasses or vinasse, for example. At this stage of treatment, the extinguisher powder is made sufficiently cohesive to prevent dispersion of particles and to allow easy handling. The product obtained can then be used by manufacturers of chemical and/or organic compound fertilizer for the production of compound fertilizers. In a second phase, it is proposed to add to the mix obtained a drying agent based in particular on ground and dried plant materials and more specifically based on fruit pulp, grape pulp, for example. The obtained product can then be directly used by farmers as a fertilizer.

More generally, the method of this invention is an extinguisher powder waste treatment method with recycling in mind. This method includes the stage that involves mixing the powder with a cohesive viscous agent to be used in the manufacture of fertilizer. According to this invention, the method consists, more particularly, of mixing the powder with the cohesive viscous agent in an initial stage, then drying the mix obtained with ground dried plant materials.

Because of the drying of the mixture of powder and the viscous agent, the fertilizer obtained can easily and directly be applied by the agricultural user. This fertilizer comes in a powdery form, and it is soluble in water so that it can be easily applied with a fertilizer spreader. The use of a drying agent avoids a granulation phase of the product thus saving production costs between 20% and 30%. Also, the addition of ground dried plant materials avoids having to add micro-elements to the mixture of powder and viscous agent. In fact, the ground dried plant materials, fruit pulp especially, are rich in organic humus material, and contain, for example, organic nitrogen, so-called slow release, and humic acid. In addition, the ground dried plant materials favor soil preservation, by being used as an ingredient element of organic/mineral fertilizer and organic enhancements, highly humus-producing raw materials. More particularly, the ground plant materials favor the retention of ground water and improve soil structure, significantly increases the organic matter content of the soil and encourages its warming, improves the mechanical strength of the soil to fight erosion, and stimulates microbial life.

The cohesive agent is advantageously a sugar by-product, such as molasses and/or beet vinasse.

The ground plant materials are preferably from fruit pulp; notably grape pulp.

The mixture of powders, cohesive agent and dried ground plant materials is notably made with a respective proportion from 40% to 90% of extinguisher powder, and between 5% and 30% of cohesive agent. To this mixture, the dried ground plant materials are added in a 5% to 30% proportion. Ideally the mixture of powder, cohesive agent and dried ground plant material is notably made in a respective proportion between from 80% (sic) and 80% of extinguisher powder, between 5% and 15% of cohesive viscous agent. The dried ground plant materials are added to this mixture in a proportion notably between 5% and 20%.

In its generality, one will recognize a fertilizer of this invention in that it consists of extinguisher powder in a proportion ranging from 40% to 90%, cohesive agent from 5% to 30% and ground plant materials from 5% to 30%.

This fertilizer consists more particularly of a mixture of extinguisher powder, sugar by-product and dried ground plant materials. Because of these conditions, the obtained fertilizer comes as a fluid but not dusty powder, avoiding an irritating effect on the eyes and mucous glands, and allowing for a spreading by the agricultural user.

The obtained fertilizer contains notably, according to an initial example, 10% nitrogen and 20% phosphoric acid or yet, according to another example, 7% to 9% nitrogen, in which 0.6% is organic nitrogen, and 7% to 12% phosphoric oxide, and 0.4% to 1.4% potassium.

The fertilizer obtained is readily soluble in water and it can be used by standard commercial fertilizer spreaders.

1. Method for treatment of fire extinguisher powder waste, the waste being based on ammonium sulfate and ammonium phosphate and/or potassium carbonate and potassium sulfate, the waste being prepared for recycling in fertilizer production, said method comprising the steps of:
mixing powder waste with a cohesive viscous agent; and
drying the mixture with a dried ground plant material.

2. Method for treating extinguisher powder waste, according to claim 1, wherein the cohesive agent is comprised of a sugar by-product.

3. Method for treating extinguisher powder waste, according to claim 2, wherein the cohesive agent is comprised of molasses.

4. Method for treating extinguisher powder waste, according to claim 2, wherein the cohesive agent is comprised of beet vinasse.

5. Method for treating extinguisher powder waste, according to claim 1, wherein the ground plant material is comprised of fruit pulp.

6. Method for treating extinguisher powder waste, according to claim 5, wherein the ground plant material is comprised of grape pulp.

7. Method for treating extinguisher powder, according to claim 1, wherein said waste powder, is made in a proportion of 40% to 90%, wherein the cohesive agent is made in a proportion of 5% to 30%, and wherein the ground plant material is made in a proportion of 5% to 30%.

8. Fertilizer, obtained by a method for treating extinguisher powder based on ammonium sulfate and ammonium phosphate and/or potassium carbonate and potassium sulfate, according to claim 1, said fertilizer comprising:
a powder being comprised of extinguisher powder;
a cohesive agent mixed with said powder; and
ground plant material mixed with said powder and said cohesive agent.

9. Fertilizer, according to claim 8 wherein said waste powder is made in a proportion ranging from 90% to 40%, wherein the cohesive agent is made in a proportion ranging from 5% to 30%, and wherein the ground plant material is made in a proportion from 5% to 30%.
